(19) United States
(12) Patent Application Publication
(10) Pub. No.: US 2008/0120188 A1
(43) Pub. Date: May 22, 2008

(54) FOOD TEMPERATURE COLLECTION, STORAGE AND RETRIEVAL SYSTEM

(76) Inventors: Jason Mobley, Melbourne, FL (US); Kevin J. Russell, Melbourne, FL (US); Jeff Birmingham, Palm Bay, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/839,124

(22) Filed: Aug. 15, 2007

Related U.S. Application Data
(60) Provisional application No. 60/822,420, filed on Aug. 15, 2006.

(51) Int. Cl. G06Q 50/00; G06F 15/00

(52) U.S. Cl. 705/15; 702/130

(57) ABSTRACT

An automated system for collecting, storing and retrieving temperature data relative to food items and food storage equipment includes a hand-held display and data input unit coupled to a temperature probe. The system may include, in the hand-held unit, a memory element for storing one or more predetermined temperature ranges for each one of a plurality of food items or food storage equipment items; and, the memory element maintains a log having temperature data relative to measured temperatures of food items and/or food storage equipment including the date and time when temperatures were measured. The system also comprises a processor that assigns a log number to a temperature measurement taken of a food item or the food storage equipment, and the memory element stores the log number with the date, time and measured temperature associated with the food item or food storage equipment.

### CROSS-REFERENCE TO RELATED APPLICATIONS

This application claims the benefit, under Section 119(e), of the provisional application filed on Aug. 15, 2006, and assigned Application No. 60/822,420.

### FIELD OF THE INVENTION

The present invention relates to information storage and retrieval systems and subsystems thereof. More specifically embodiments of the invention are directed to the use of a hand-held food and/or equipment temperature collections, storage and retrieval system, comprising an internal processor or microcontroller programmed and memory element to control and expedite measuring and recording temperatures of a plurality of food items and food storage or cooking equipment in a food service facility, such as a restaurant, so that a retrievable temperature log may be maintained for such food items and ingredients to facilitate compliance with health and food safety codes, regulations or standards.

### BACKGROUND OF THE INVENTION

Generally, the food service industry follows the Hazard Analysis and Critical Control Points (HACCP), which is a systematic preventive approach to food safety and has been incorporated in legislation in the United States and other countries. More specifically, acceptable temperature ranges for food storage and food preparation have been incorporated in laws, codes, regulations etc. In addition, privately-owned companies that operate food service facilities may adopt food safety standards that are more stringent than those standards adopted by government entities or agencies. Food service facilities, such as restaurants, cafeterias and the like, are customarily required to measure the actual temperature of the food items within food storage areas and to maintain a record of these measurements for review by third parties (e.g., representatives of a parent/owner company and by health department personnel). In addition, the temperatures of food preparation equipment or food storage areas, such as walk-in coolers, freezers, food holding units and the like, are monitored and recorded.

Taking the case of a delicatessen as a non-limiting example, a food safety temperature recording log, in the form of a spreadsheet includes a list of food items and food storage equipment, and is used to record and log temperatures of food items and the equipment. The temperature of food items or equipment is measured (usually at least twice a day) typically using a hand-held digital thermometer. The measurements are manually recorded by an individual taking the measurements. Recording the measurements builds a paper trail that allows health department or supervisory personnel to determine whether a problem exists, which may constitute a potential health risk to facility patrons.

A practical problem with measuring and manually recording temperatures in this manner is that it is cumbersome, subject to human error and depends upon the faithfulness of the individual charged with the duty of taking the measurements, despite more immediate tasks that must be addressed. Indeed, it is sometimes the case that temperature records are created without actually conducting the temperature measurements. Moreover, if the measurements indicate that a food item or equipment temperature is not within an acceptable range and thereby requires remedial attention such information is typically not immediately available to personnel. Not having the remedial actions available may result in a delay in undertaking corrective action or the lack of undertaking any corrective action.

In addition to the above-referenced manual recordation of food and equipment temperatures, corrective actions relative to food items or food storage equipment are manually recorded on an action log spreadsheet providing a date and time of temperature measurements and a description of a corrective action taken. An individual who supervises a plurality of food service facilities, such as a district manager of a plurality of franchise restaurants, will not know of food temperature issues, the need for correction action or the outcome of the corrective action unless he receives timely and complete food temperature reports. Accordingly, a need exists in food service facilities for an automated system that collects and records temperature data relative to food items and food storage equipment, and also provides an automated instruction on a correction action to be taken in the event the temperature of a food item or equipment does not fall within a predetermined temperature range. In addition, a need exists for a system that provides for the automated recording of corrective actions taken in order to bring temperatures of food items or equipment in compliance with predetermined food storage standards.

### BRIEF DESCRIPTION OF THE INVENTION

An embodiment of the invention for an automated system for collecting, storing and retrieving temperature data relative to food items and food storage equipment comprises a hand-held display and data input unit coupled to a temperature probe. The system comprises, in the hand-held unit, a memory element for storing one or more predetermined temperature ranges for each one of a plurality of food items or food storage equipment items; and, the memory element maintains a log having temperature data relative to measured temperatures of food items and/or food storage equipment including the date and time when temperatures were measured. The system also comprises a processor that assigns a log number to a temperature measurement taken of a food item or the food storage equipment, and the memory element stores the log number with the date, time and measured temperature associated with the food item or food storage equipment.

The hand-held unit may also display user-selectable options responsive to an out-of-range food item temperature or equipment temperature, which options may include re-measuring the temperature of the food item or food storage equipment, initiating a corrective action process and, in the case of a food item, disposing of the food item. In the event that the re-measurement option is selected, the processor assigns the same log number to the re-measured temperature with a corresponding date and time associated with the food item or food storage equipment of a first temperature measurement. The processor, responsive to a command, may also initiate the corrective action process responsive to an out-of-range temperature measurement of a food item or food storage equipment that includes an instruction on how to restore the temperature of the food item or food storage equipment within the predetermined temperature range. After the corrective action has been taken a second measurement may be taken which measurement is assigned the same log number as the first measurement, with a corresponding date and time. Alternatively, if the option for disposal of food is selected, the same log number is maintained for this action and food item or food storage equipment.

In this manner, the temperature measurement data may be reviewed to determine appropriate steps have been taken to correct the out-of-range temperature measurement. To that end, in an embodiment of the invention the memory element can be interfaced with a computer to download the food item and food storage equipment temperature measurements. The computer is programmed to generate a temperature log report preferably in a spreadsheet format, and data in the report can be sorted according to different data fields such as dates, the particular food item or food storage equipment measured or the log number associated with the food item or food storage equipment and the temperature measurement. Accordingly, in the case of the detection of an out-of-range temperature, a user may access the temperature log report, identify an out-range-temperature measurement and sort the data according to the assigned log number to determine what, if anything was done to address the out-of-range temperature measurement.

In addition, the system may also include an Internet-based website for loading and accessing temperature measurement logs and the corrective action logs by personnel remotely located with respect to those users taking temperature measurements.

### BRIEF DESCRIPTION OF THE DRAWINGS

A more particular description of the embodiments of the invention will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 diagrammatically illustrates a programmable food temperature collection, storage and retrieval system and a temperature probe coupled thereto of an embodiment of the invention.

FIGS. 2-6 diagrammatically illustrate flow charts depicting routines associated with operation of the food temperature collection, storage and retrieval system of FIG. 1.

FIGS. 7-14 diagrammatically illustrate screen displays of routines associated with operation of the food temperature collection, storage and retrieval system of FIG. 1.

FIG. 15 diagrammatically illustrates a screen display of a computer program illustrating entry of parameters associated with the operation of the food temperature collection, storage and retrieval system of FIG. 1.

FIG. 16 diagrammatically illustrates a screen display of a computer program illustrating a temperature log of temperature measurements sorted in chronological order and associated with the operation of the food temperature collection, storage and retrieval system of FIG. 1.

### DESCRIPTION OF THE INVENTION

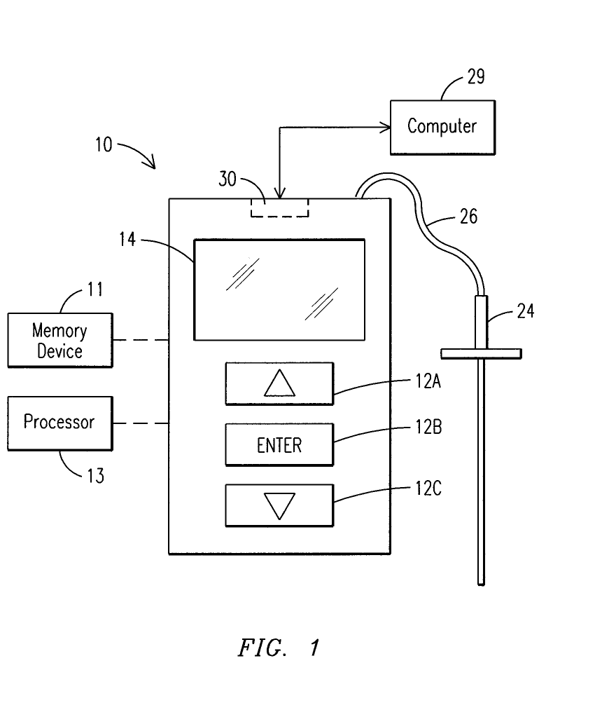

In accordance with the present invention, rather than rely on food service personnel to manually record temperature measurements and maintain a paper log compilation of such measurements, the individual charged with the task of conducting the measurements operates a hand-held temperature collection, storage and retrieval device (a data logging device) 10 illustrated in FIG. 1. The device 10, comprising an ascending scrolling key 12A, an enter key 12B, a descending scrolling key 12C and a display 14, is coupled to a temperature probe 24 via a conductor 26 (such as by through a serial port or a USB link) or by a wireless link (not shown). The user manipulates and selects text items or commands presented in the display 14 by operation of the scrolling keys 12A and 12C and enter key 12B, and responsive thereto is guided through the various processes or routines presented by the device 10.

As further described below, the device 10 has a memory element 11 and a processor 13 to automatically record each temperature measurement according to the date, time of day, location of the food item (such as the sandwich unit, reach-in cooler, walk-in cooler, hot hold, cold hold and freezer units) of the food service facility. The device 10 also records temperature measurements of food storage equipment (such as the sandwich unit, reach-in cooler, walk-in cooler and freezer units) according date and time of day. In addition, as explained in more detail, a log number is assigned to each recorded temperature measurement. In one embodiment the month/day/year/time data is also presented on the display 14 when temperature measurements and/or corrective action information is presented.

The display 14 may further include an icon providing a visual indication of the amount of memory in use to store the temperature and corrective action information. This information allows the user to determine when to transfer the data to the computer or data processing device 29 and thereby free up the device's memory. The display 14 also includes an icon providing a visual indication of batter life.

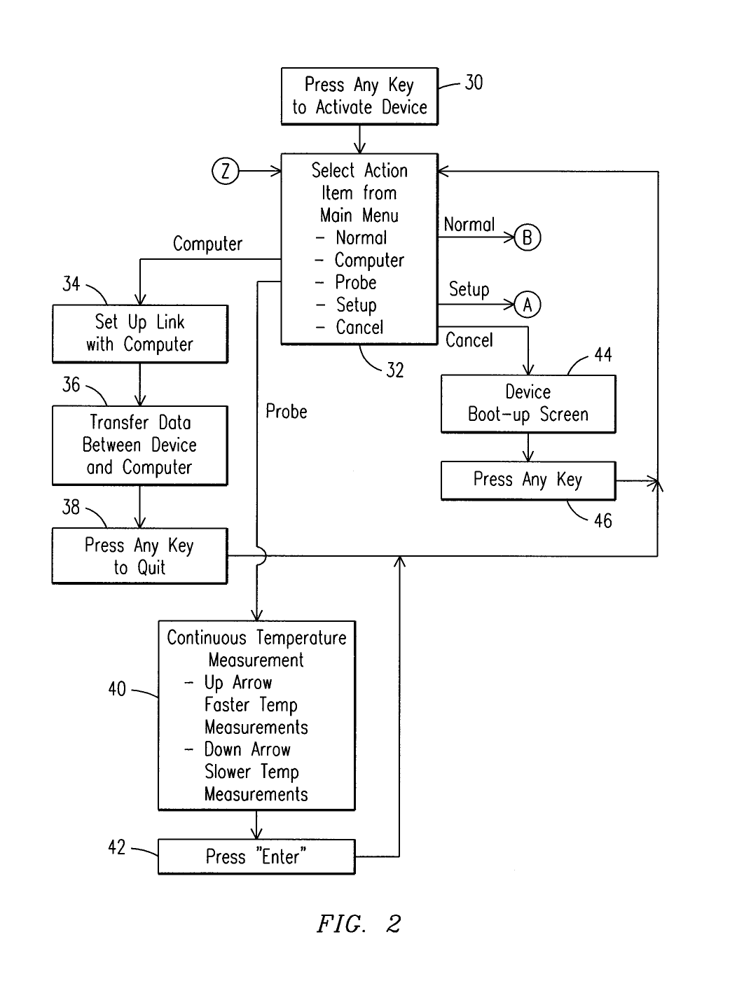

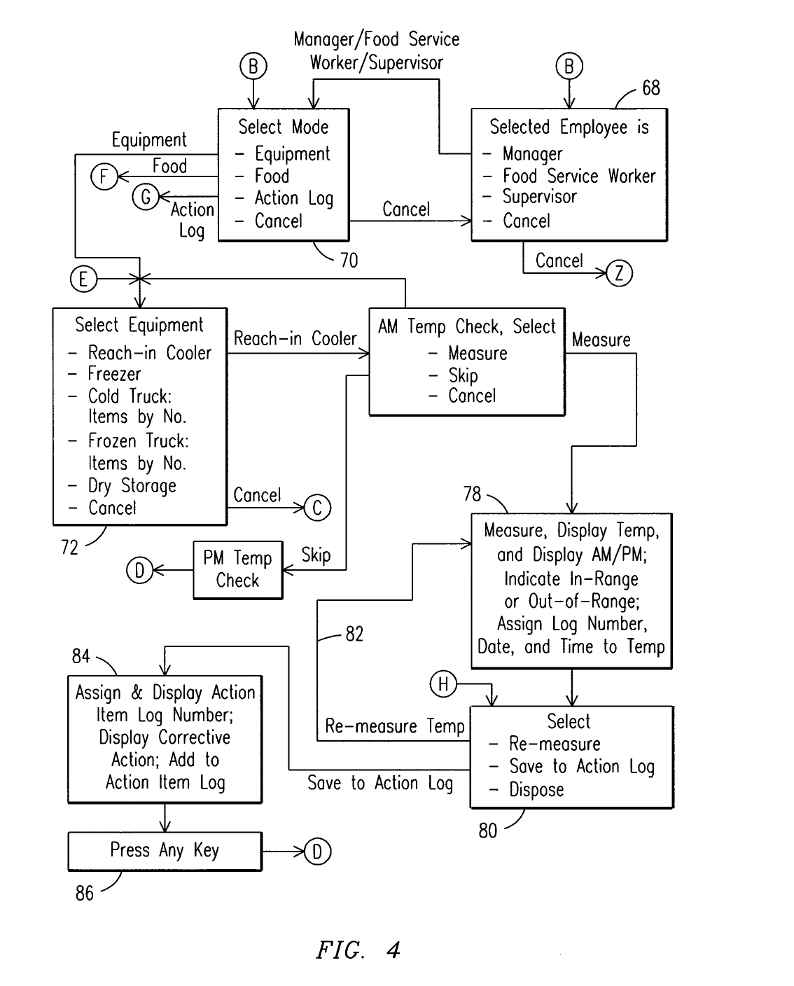

With respect to FIG. 2, block 32, the device 10 operates in one of several operational modes, including a normal mode, a computer mode, a probe mode, a set-up. In reference to FIG. 4, block 68, the normal mode further comprises an equipment mode (wherein the user is prompted to measure food storage equipment temperatures), a food mode (wherein the user is prompted to measure food item temperatures), an action log mode (wherein the user reviews the status of corrective actions for out-of-range temperature measurements) and a cancel mode which allows the user exit an operating mode to return to previously accessed menus or screens.

The device may also have a default sleep mode, which is activated in one embodiment after about five minutes of inactivity. With respect to FIG. 2, block 30, a user may press any of the keys 12A, 12B or 12C to activate the display 14. When the device 10 wakes from the sleep mode the display 14 is in the previously operative mode (i.e. the active mode prior to onset of the sleep mode) with the previous user logged-in as the current user. If the current user desires to select a different operational mode or log in as a different user, the user selects the cancel mode (by scrolling through the presented modes by operating the scrolling keys 12A and 12C and selecting the desired mode by operating the enter key 12B). Now presented with a main menu 32 the user can select and enter the normal mode, probe mode, computer mode, set-up mode and the cancel mode.

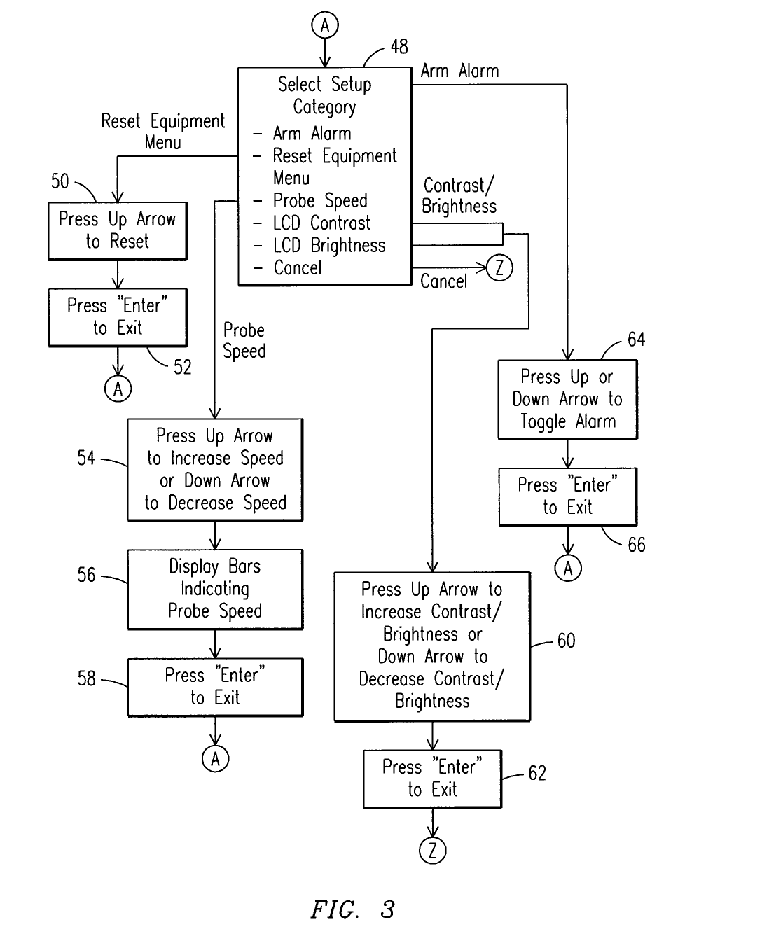

A description of the different modes of operation is now provided. Again in reference to FIG. 2, there is illustrated a flow chart including blocks 30 through 46, which may represent and be referred to as menus shown on the display 14 of the device 10 or the blocks may also be characterized as steps performed during operation of the device. Similar references to blocks, menus or steps are used in the other flowcharts illustrated in FIGS. 3 through 6. Note that the invention is not limited to the particular identification of operational modes, food items or food storage equipment, and the device can be customized to include different names of modes, food items or food storage equipment as necessary for operation. In addition, the terms “food storage equipment” and “food storage location” are used herein interchangeably and refer to the same items.

### Computer Mode

In the computer mode routines and/or data as described below may be downloaded to the device 10 from the computer 29. In addition, temperature measurements and related data may be downloaded from the device to the computer 29, which has software that manipulates the data for review and analysis. An operator executes a software application running on the computer or processing device 29 to prepare the routines to be performed with the device 10. The software application prompts the operator for the location of the food service facility where the device 10 will be operated; the food items used there, the food storage facilities at the location, the names of authorized users at the facility and the permissible temperature range for each of the food items and the food storage equipment.

Responsive to the prompts, the operator enters the requested information or selects items from presented menus responsive to the prompts. Corrective action processes for food products that are beyond a desired temperature range are also entered by the operator. Alternatively, such corrective actions are programmed into the software application. In either case, the corrective actions are associated with food items and out-of-range temperature measurements for later use during operation of the device 10.

Other user-controllable operational features of the device 10 can be programmed by the computer or processing device 29. For example, the control routine includes a programmable calendar that alters certain functional operations of the device 10 on a daily basis according to calendar entries. The food mode can be programmed by indicating the food items that are to be checked for each day of the month. For example, a cafeteria user programs the food products that are to be checked each day of the month based on the day's menu.

When the user has completed executing through the software application, the device control routines are prepared and uploaded to the device 10 for control thereof during operation. The device 10 can later be returned to the computer mode, connected to the computer or processing device 29 to effect further changes or modifications to the device's control routines.

In FIG. 2, in step 32 prior to operation, the computer mode is selected. In step 34, the device 10 is connected to a computer or processing device 29 via any suitable interface 30 (comprising, for example, an Ethernet link, a serial port link, a USB link or a wireless link) for downloading data from the computer to the to the device 10, which data representative of the different food items and food storage equipment to be monitored and one or more predetermined temperature ranges associated with each of the food items or food storage equipment. The temperature ranges are representative of safe operating temperatures for food storage as determined by the user or by known safety laws, codes or regulations.

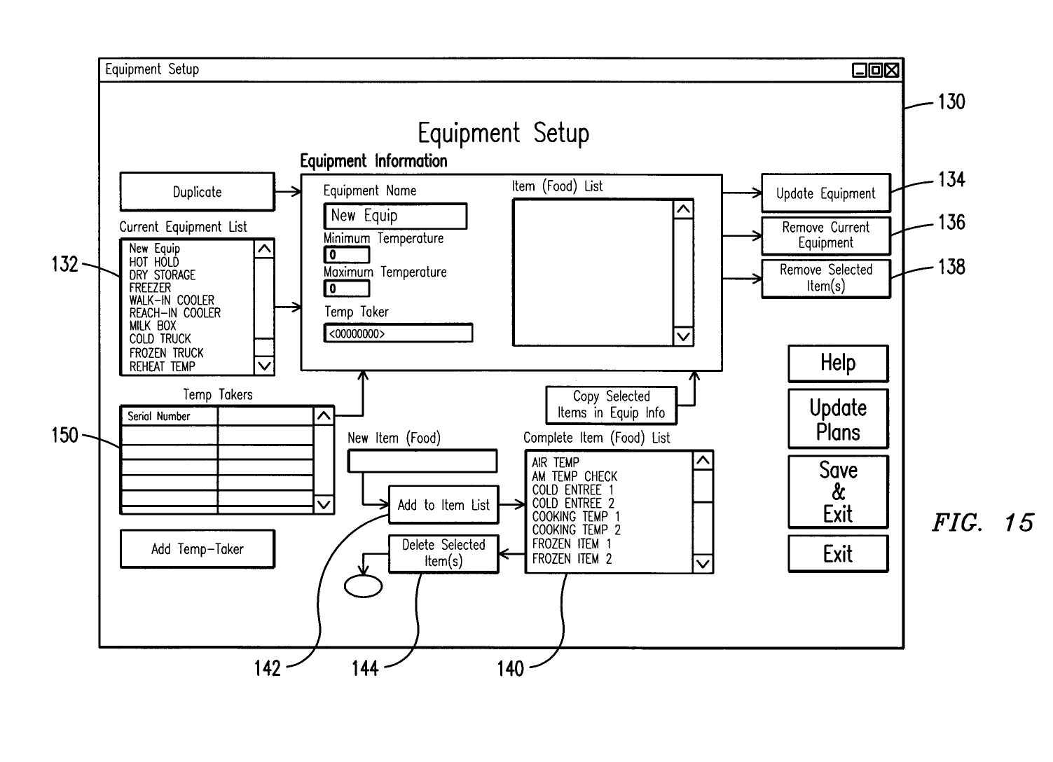

In FIG. 15, there is shown an example display screen 130 of the computer 29 which shows the different data fields available for entry of data. For example, there is shown an equipment list 132 including for example HOT HOLD, DRY STORAGE, FREEZER, WALK IN COOLER, COLD TRUCK etc, all of which are different types of food storage equipment in which the food items are stored. Note that the names of the particular food storage equipment or locations are not limited those shown listed above. The software application of the software can customize the device to include any names of food storage locations.

The commands 134, 136 and 138 allow a user to update the equipment list, remove the list in its entirety or remove only selected items. Similarly, there is shown a food item list 140 that includes COLD ENTRÉE 1, COLD ENTRÉE 2, COOKING TEMPERATURE 1 etc, and commands 142 and 144 that allow the user to add or delete food items respectively. In addition the data fields 146 and 148 are for entry of the minimum and maximum temperatures. Note that the names of the particular food items are not limited those shown listed above. The software application of the software can customize the device to include any names of food items.

The software application may also include a serial number data field 150 that allows a user to enter the serial number of the device 10. A food service facility may utilize a plurality of the devices 10 and each device may be programmed to include different food items or food storage equipment. For example, one device may be used to solely measure temperatures for food items, another device may be used to solely measure the temperatures of the food storage equipment or each device may be used to measure temperatures of food items in a specific food storage location.

As explained in more detail below, when temperature measurements are uploaded from the device 10 to the computer 29, the software on the computer is programmed to create a temperature log spreadsheet on command. The software is arranged so that each food item is associated with a particular food storage equipment item. For example, COLD ITEM 1 may be stored in the “COLD TRUCK.” Note the food items list also includes such items as AM TEMP CHK and PM TEMP CHK. Each of these items is not actually a food item but identify an air temperature check within a particular piece of food storage equipment, such as a freezer.

After step 36 in which the transfer of the data from the computer 29 to the device 10 is complete, any key 12A, 12B or 12C is pressed (step 38) and the user is returned to the main menu, screen 32.

### Probe/Setup/Cancel Modes

In the probe mode, only the probe and the temperature measuring components of the device 10 are activated, permitting the user to simply measure a product temperature. No data is recorded by the device 10 and an action log for remediating out-of-range temperatures is not created during probe mode operation. As shown in step 40, the rate at which the probe 24 may take the temperatures may be adjusted using the scroll keys 12A and 12C. After temperature measurements are completed in step 42, any key 12A, 12B or 12C to return to the main menu 32.

With respect to FIG. 3, on menu 48 the set mode has been selected and various routines are identified. In the setup mode certain user controllable options such as control of the display contrast and brightness (see steps 60 and 62), are accessible. In addition, in steps 64 and 66, an alarm volume may be adjusted; and, in steps 56, 57 and 58 the probe speed may be adjusted.

The cancel mode, appears on the main menu 32 of FIG. 1, and also appears on other screens or menus throughout the operation of device 10. The cancel mode terminates the current mode and returns operation to the previous menu or to the sign-on menu 68 (FIG. 4).

### Normal Mode

With respect to FIG. 4, after the user selects the normal mode names and/or positions of all authorized users are displayed on the display 14 (as shown in menu 68) and the current user merely scrolls through the list and selects his/her name. All subsequent temperature measurements or action item log entries are associated with this user. In another embodiment, the device 10 prompts the user to enter a name or other identification information in free style text form. After the user selects his/her name the, an additional menu screen 70 is presented from which the user can select the equipment mode, the food mode or the action log mode.

In the equipment mode and the food mode, the device 10, through prompts shown on the display 14, guides the user through a programmed routine during which the user is prompted to determine the temperature of identified food products or food storage equipment. Each measurement is declared either in-range or out-of-range and a corrective action plan, as described below, is set forth for the latter case.

### Equipment Mode

In reference to FIG. 4 and menu screens 72 and 74, the equipment mode has been selected from the previous menu 70. In this particular example, the “reach-in cooler” has been selected and the menu 74 displays that the AM TEMP CHK options including—measure, -skip or -cancel. On menu 78, the user takes the temperature measurement by suspending the probe 24 within the reach-in cooler to take a temperature measurement. The device 10 then displays data relative to the measurement including: 1) an assigned measured log number, 2) the temperature 3) the date and time the measurement was taken and 3) an indication whether the temperature is within the predetermined range, i.e. 33° F. to 41° F.

An example of a display 14 where the measured temperature is within range is shown in FIG. 7. Note that the processor 13 and/or device 10 has assigned a log number (12500007) to the measurement and the data displayed on the display 14 is automatically recorded in the memory element 11 as a log item which may be displayed in a temperature log report discussed in more detail below.

In the event, the temperature is out-of-range menu 80 is displayed providing the options: 1) to re-measure the temperature; 2) save the measurement to the action log; or, 3) dispose of the item (assuming it is a food item). As shown by arrow 82, in FIG. 4, if the item is re-measured the menu 78 is again displayed indicating whether the temperature is in-range or out-of-range. Note that the log number for this food item or this particular food storage equipment shall remain the same for the re-measurement. Indeed, once a first measurement is taken of a food item or food storage equipment, and the temperature is out of range, any subsequent temperature or action taken with respect to an out-of-range measurement, the log number shall remain the same for the respective food item or food-storage equipment. If the temperature measurement is in range, then subsequent temperature measurements of the same food item or food storage equipment will be assigned a different log number.

If “save to action log” is selected menu 84 displays the log number with a corrective action to be taken. More detail with respect to correction action will be provided below under the heading ACTION LOG.

### Food Mode

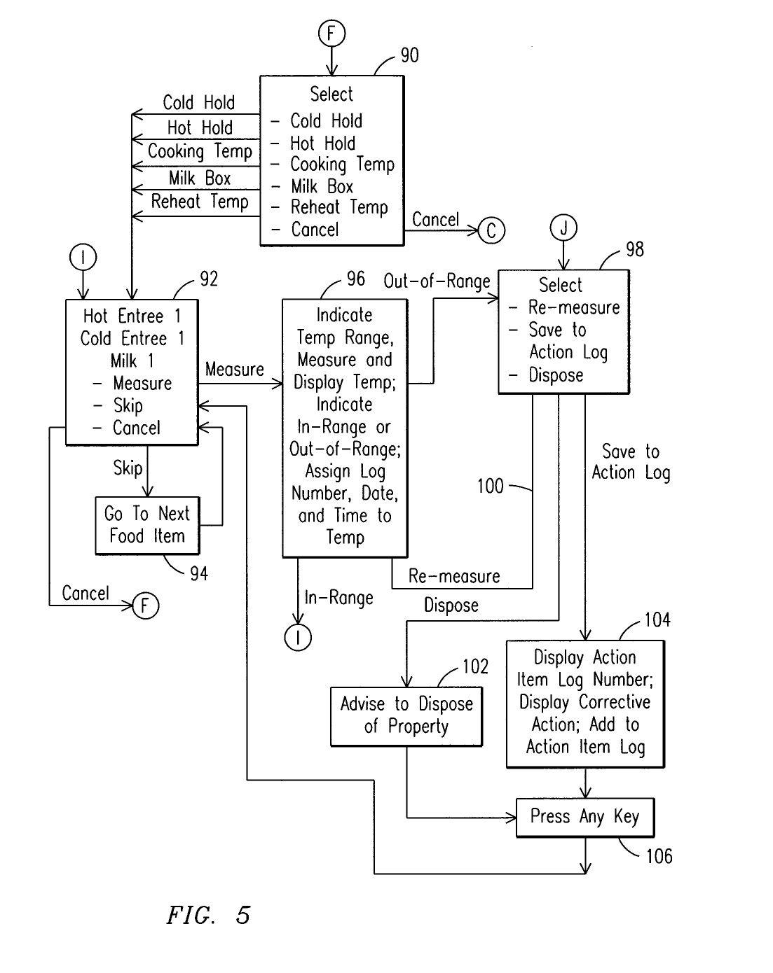

In reference to FIG. 5, a flowchart is provided that depicts menus and/steps taken when the food mode is selected. In the food mode, menu 90 displays a list of locations or food storage locations which hold different food items. Once the food storage location is selected in menu 90, the menu 92 displays a food item at the selected food storage location with options to measure the food item, skip to the next food item at the selected location or cancel to return to menu 90. The food storage location and food item are selected by scrolling through the lists with keys 12A and 12C, and an item is selected by pressing the enter key 12B.

When the temperature is measured by inserting the probe 24 into the food item in step 96 a text entry on the display 14 indicates whether the measured temperature is within a predetermined range, in which case no further action is required. As noted above the measurement is assigned a log number, and the date and time of measurement, the log number and the food item and food storage location are stored in the memory element 11. As shown in FIG. 5 if the temperature is in range the user may return to menu 92 by pressing any key.

In addition, the user may select the option of disposing of the food item as set forth in step 102, after which in step 106 any key is pressed to return the user to menu 92 which shall displace the next food item in the list that is stored in the selected food storage location. An example of the display 14 with text indicating disposal of a food item is shown in FIGS. 13 and 14. In this example, the temperature of the food item MILK 1 has been taken and determined to be out of range, and with respect to FIG. 13, the user has elected to dispose of the food item. In FIG. 14, the processor 13 has marked the food item as described, and the disposed status of the food item including date, time and log number are recorded and stored in memory element 11.

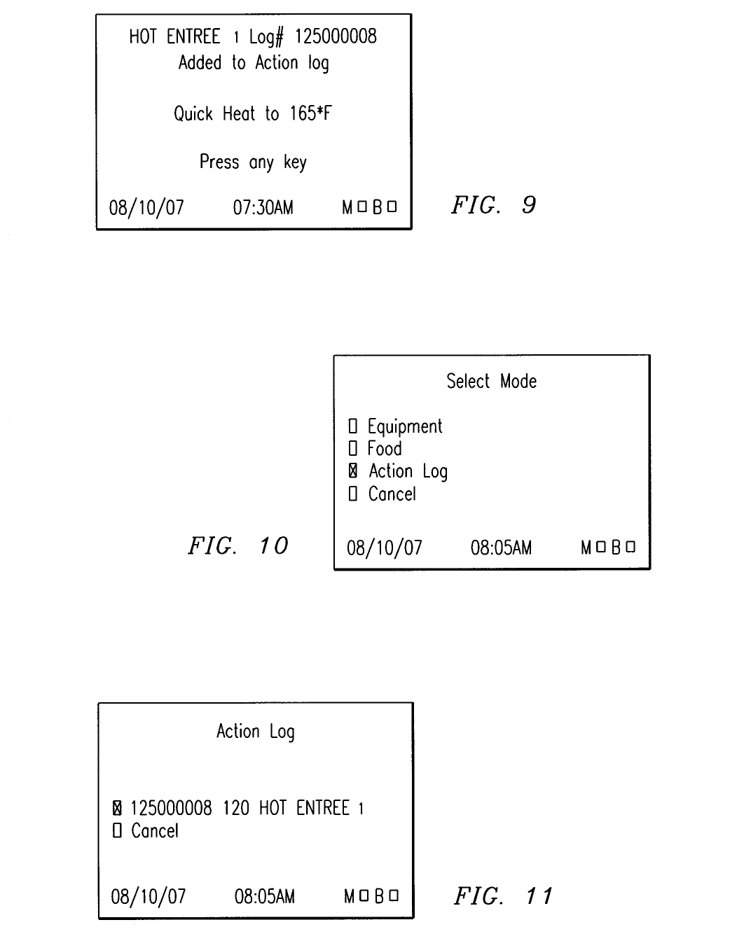

Alternatively, in the event of an out-range-temperature, in menu 98 the user may elect to save the temperature in an action log. In step 104, the device displays the food item, log number, the corrective action to be taken and confirms that the data relative to the temperature and food item have been stored in the action log. The display 14 shown in FIGS. 8 and 9 provides an example of an out-of-range temperature of food item, HOT ENTRÉE 1. As shown in FIG. 8, the display 14 provides the log number, food item selected and measured, the measured temperature, an indication that the temperate is out-of-range and the previously discussed options including save to action log, which has been selected.

In FIG. 9, after save to action log has been selected, the display 14 provides text that includes the food item, an indication that the data relative to the food item has been stored to the action log and an instruction on what to do to bring the out-of-range temperature within the predetermined temperature. In this example, the user is instructed to “Quick Heat to 165° F. Such a corrective action item or process is based on food safety compliance instructions/directions/actions, and if implemented will return the food item to a safe storing and serving temperature. The corrective action process may be undertaken twice if the temperature measurement at the end of the first corrective action period is not within a specified range within a specified time from the initial out-of-range measurement. Typically, if the second corrective action attempt does not return the food item to a safe condition the presented action is to discard the food item.

### Action Log Mode

When corrective action is required for an out-of-range temperature, the device 10 generates a corrective action log. Data relative to a food item, food storage equipment, log numbers and temperature measurements for the same are stored in the action log of the memory element. This data includes one or more measured temperatures to determine if the corrective action taken has brought the temperature of the food item and/or food storage equipment within the predetermined temperature range. The user is also requested to perform a temperature remeasurement at this time.

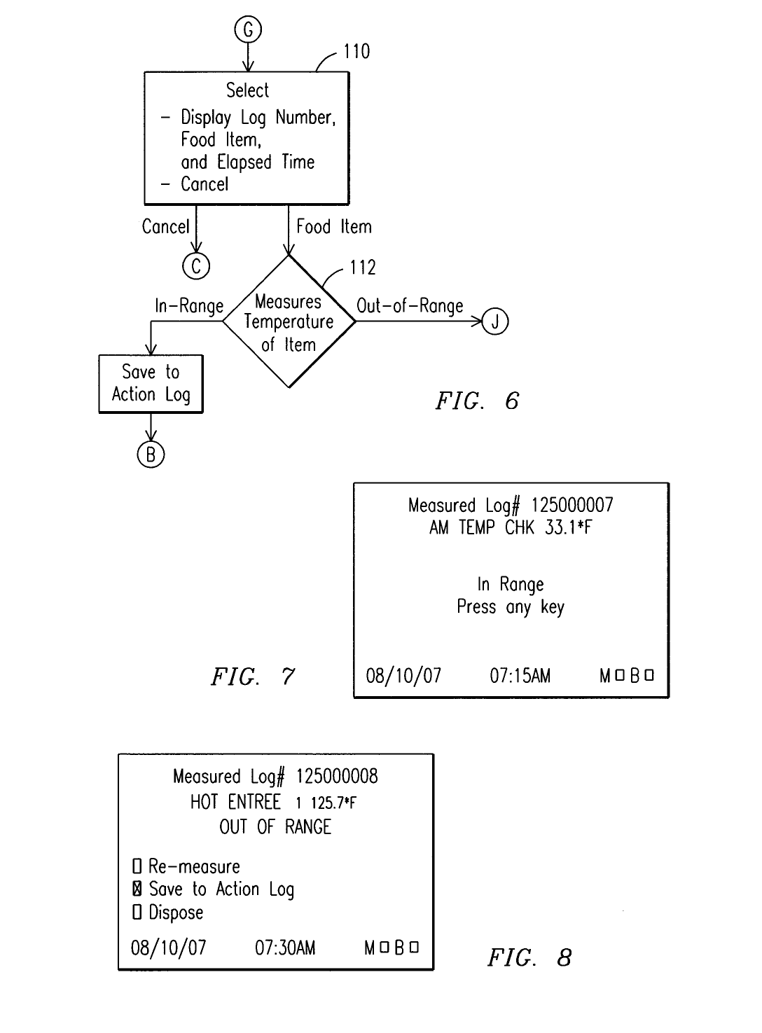

With respect to FIG. 6, there is illustrated a flowchart following the routines of the action log mode of the device 10; and, FIGS. 10, 11 and 12 provide an example of text of the display 14 of device operating during the action log mode. In FIG. 6, in order to get to menu 110, the normal mode is selected from the main menu 32 and the action log mode is selected on the mode menu 70. Once in the action log mode, the screen 110 displays the one or more actions undertaken and displays the log number, the food item and the elapsed time within which a corrective action must be taken. If the corrective action is not taken within the time allowed the device 10 activates an alarm to remind the user to take the corrective action. In addition, one or more alarms may sound during the predetermined time period within which the corrective action must be taken to remind the user to undertake the corrective action.

Once the user selects the action log in menu 110, the user takes a temperature measurement of the food item or food storage equipment in step 112. If the temperature is within range then in step 114, the device 10 displays the mode menu 70 on the display 14. The temperature measurement will be saved in the action log with the same log number as the first temperature measurement, and a report, as explained below will show both measurements demonstrating that a corrective action has been taken and the temperature has been placed in range.

In the event the second temperature measurement is out of range, the device 10, as represented by arrow 116 prompts the user to menu 80 or 98 to determine if the user is to re-measure the temperature, save the temperature measurement to the action log or dispose of the item, if it is a food item. If it is a food item and it is not disposed of, a temperature log (described below) generated by the computer 29 will demonstrate either that no action was taken by virtue of no further temperatures were taken or the user took several temperature measurements but was not able to bring the temperature into range within the predetermined time period.

In FIGS. 8 through 12 there are provided examples of the display screen where an out-range temperature was detected for food item designated HOT ENTRÉE 1. As previously described in the above description of the food mode and FIGS. 8 and 9, the food item temperature was detected as out of range, which information was saved to the action log. In order to access the status of the action, the user goes to the mode menu shown in FIG. 10 (also referenced as menu 70 in FIG. 4) and selects the action log. As shown in FIG. 11 an action log item is listed including the log number (125000008), the remaining time (120 minutes) within which the corrective action must be taken and the identity of the food item (HOT ENTRÉE 1). In this example, this the action item saved to the action log in FIGS. 8 and 9.

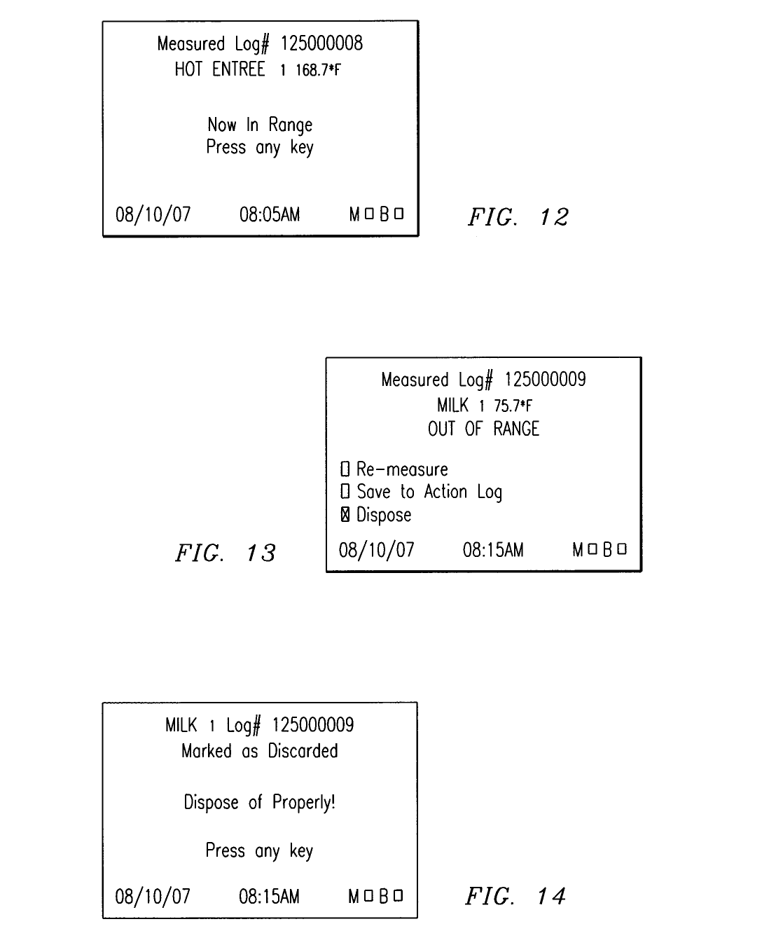

In FIGS. 11 and 12, once the user selects the log item, the users takes a temperature measurement of the food item. As shown in FIG. 12, the display 14 provides text indicating the temperature (168.7° F.) is now in range. This data is saved to the action. Note this data entry for the second temperature measurement is stored separately than the temperature measurements referred to in FIGS. 8 and 9, so that when a temperature log is generated via the computer 29, the user can determine that the corrective action was taken to bring the temperature in range.

### Temperature Log

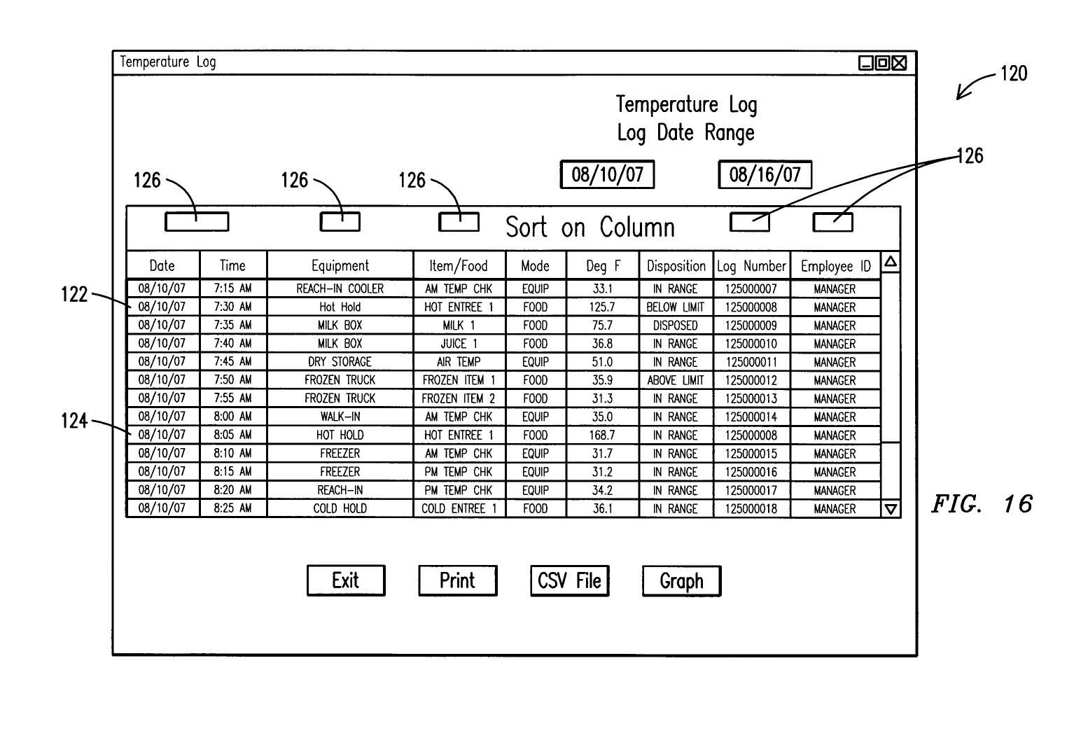

As further shown in FIGS. 1 and 16, in accordance with an embodiment of the invention the device 10 uploads (on a programmable schedule) the collected temperature information, corrective action log information and associated parameters to the computer or data processing device 29. In one embodiment the computer or processing device 29 comprises a local computer, processor, server or other remote device. The uploaded information comprises the measured temperatures for the food items, measurement date and time, user who took the measurements, operational mode of the device 10 when the temperature measurements were taken, and corrective action log information. When resident in the computer 29, the data can be archived, analyzed, parsed, searched, graphed, etc. or collected in a file and emailed to a third party.

Additionally, a print-out of temperature measurements and related information may be provided from via the interface 30. Any remote devices, such as the computer or processing device 29, can be coupled to the device 10 by a communications link (optical, WiFi, Bluetooth, etc.) via the interface 30, which can comprise a serial, USB, wireless, etc. port. This ability to provide a print out of the archival data is particularly useful if a complaint has been made by a facility customer (for example, a customer complaint that the consumed food made him/her ill). Accessing and analyzing the stored information, especially historical information, allows the food facility operator to assess the merits of any such complaints.

By way of example a temperature log 120 is illustrated in FIG. 16. In this example, the data entries are sorted in the chronological order in which temperature measurement were taken on the given date of Aug. 10, 2007. The second listed entry 122 is the temperature measurement for the HOT ENTRÉE 1 food item referred to above and set forth in FIGS. 8 and 9, and the assigned log number 12500007. The temperature measured is below a limit of the predetermined temperature range. The temperature was measured at 7:15 a.m., and subsequently temperature measurements of other food items or food storage equipment were taken and determined to be in range or out of range. The entry designated 124 shows that the food item HOT ENTRÉE 1 temperature was measured again at 8:05 a.m. Note, a user knows this is the same food item because the temperature measurement is assigned the same log number 12500007. In addition, the user knows that appropriate corrective action was taken because the second temperature is in range and was taken at a time (35 minutes later) taken within the predetermined time period (120 minutes) necessary to complete the corrective action. Software applications used on the computer may also be able to sort the data entries according to different data fields. For example, the data may be sorted according to log number. In this manner, when the user sees an out-of-range temperature by clicking on sort buttons 126 including the log number and more readily identify whether the corrective action has been taken within the predetermined time period.

While the invention has been described with reference to preferred embodiments, it will be understood by those skilled in the art that various changes may be made and equivalent elements may be substituted for elements thereof without departing from the scope of the invention. The scope of the present invention further includes any combination of the elements from the various embodiments set forth herein. In addition, modifications may be made to adapt a particular situation to the teachings of the present invention without departing from its essential scope.

What is claimed is:

1. A food temperature collection, storage and retrieval system, comprising:
a temperature probe for measuring a food item temperature;
a memory element for storing a predetermined safe temperature range for a plurality food items and a retrievable log of food item temperatures as measured by the temperature probe, wherein the log comprises a measured temperature log number, the food item temperature and a datestamp and a timestamp indicating when the food item temperature was measured;
a display for displaying the safe temperature range, the measured temperature log number, the datestamp, the timestamp and a message indicating a temperature outside the safe temperature range; and,
a processor for prompting a corrective action process responsive to a food item out-of-range temperature, the corrective action process comprising a corrective action to be taken to bring the temperature of the food item within the safe temperature range and a corrective action log number, wherein the corrective action log number is the measured temperature log number for the food item.

2. The system of claim 1 further comprising user-activated keys and wherein the display further indicates the food item for which the temperature is measured and indicates user-selectable options responsive to the food item temperature outside the safe temperature range, the options comprising re-measuring the food item temperature or food storage equipment temperature, prompting to initiate the corrective action process and disposing of the food item.

3. The system of claim 2 wherein the display, responsive to prompting the device to initiate the corrective action, displays the corrective action to be taken to adjust the temperature to within the predetermined safe temperature range, the identity of the food item that is subject to the corrective action and for which the out-of-range temperature measurement has been taken and an action log number, wherein the action log number is the measured temperature log number for the food item.

4. The system of claim 1 wherein responsive to a user input the processor determines that the corrective action process has been completed and displays that the measured temperature is within the predetermined safe temperature range.

5. The system of claim 3 wherein the corrective action process comprises one of the following, quick heat the food item or quick chill the food item to within the predetermined safe temperature associated with that food item and dispose of the food item.

6. The system of claim 2 wherein the memory element comprises an interface for connecting the memory element to a computer for downloading the food item temperature and the corrective action log, wherein the corrective action log comprises the corrective action log number, identification of the food item associated with the action log number and the temperature measured for the food item wherein the corrective action number is the measured temperature log number for the food item.

7. The system of claim 6 wherein the interface comprises one of an Ethernet link, a serial link, a parallel link, a universal serial bus link and a wireless link.

8. The system of claim 1 wherein the retrievable log of food item temperatures further comprises an identification of a person conducting the temperature measurement.

9. The system of claim 1 wherein the temperature probe measures a food storage location temperature, and wherein the memory element stores a safe temperature range for a plurality of food storage locations and the retrievable log of food storage location temperatures, wherein the log comprises a measured food storage location temperature log number, the storage location temperature and a datestamp and a timestamp indicating when the storage location temperature was measured.

10. The system of claim 1 further comprising a plurality of operational mode prompts indicated on the display, further comprising a normal mode prompt for measuring a food item temperature or a food storage location temperature, a computer mode prompt for transferring information stored in the memory element to a computer, a probe mode prompt for configuring continuous temperature measurements by the temperature probe and a setup mode prompt for configuring the processor.

11. The system of claim 10 wherein selecting the normal mode prompt displays a prompt requesting an identification of an employee using the system.

12. The system of claim 10 wherein selecting the normal mode prompt displays a prompt requesting the user to select from an equipment mode for measuring a food storage location temperature and a food mode for measuring a food item temperature.

13. The system of claim 15 wherein selecting the equipment mode displays a prompt requesting the user to select one food storage location from a plurality of food storage locations.

14. The system of claim 12 wherein the plurality of food storage locations comprise a reach-in cooler, a freezer, a cold truck, a frozen truck or dry storage.

15. The system of claim 13 wherein a temperature of a selected food storage location is measured during an AM time interval and a PM time interval.

16. The system of claim 13 wherein after the user selects a food storage location from the plurality of food service locations the user is further prompted to measure the temperature of the selected food storage location or skip to another food storage location.

17. The system of claim 16 wherein responsive to the measured temperature outside the safe temperature range, the user is prompted to select from re-measuring the temperature of the food storage location, saving the measured temperature to an action item log or disposing of the food items stored in the food storage location.

18. The system of claim 17 wherein responsive to the user's selection of saving the measured temperature to the action item log, the display indicates the food storage location, an action item log number and nature of the food storage location problem.

19. The system of claim 15 wherein selecting the food mode displays a prompt requesting the user to select the food item from a plurality of temperature differentiated locations.

20. The system of claim 17 wherein the plurality of temperature differentiated locations comprise a cold hold location, a hot hold location, a cooking temperature location, a milk box location and a reheat temperature location.

21. The system of claim 17 wherein after the user selects the food item from the plurality of temperature-differentiated locations the user is further prompted to measure the temperature of the selected food item or skip to another food item.

22. The system of claim 20 wherein responsive to a measured temperature outside the safe temperature range, the user is prompted to select from remeasuring the temperature of the food item, saving the measured temperature to an action item log or disposing of the food item.

23. The system of claim 22 wherein responsive to the user's selection of saving the measured temperature to the action item log, the display indicates the food item, an action item log number and nature of the food item problem.

24. The system of claim 10 wherein the normal mode prompts the user to select an action item mode for reviewing action item logs.

25. An automated food temperature collection, storage and retrieval system, comprising:
a hand-held display and data input unit coupled to a temperature probe, and a plurality of keys for inputting commands;
a memory element, in the hand-held unit, for storing one or more predetermined safe temperature ranges for each one of a plurality of food items or food storage locations, and, the memory element maintains a log having temperature data relative to measured temperatures of food items or food storage locations including the date and time when temperatures were measured;
a processor, in the hand-held unit, that assigns a measured temperature log number to a temperature measurement taken of a food item or the food storage equipment, which log number is stored in the memory element the date, time and measured temperature associated with the food item or food storage equipment; and,
a display for displaying the safe temperature range, the measured temperature log number, and the date and time the temperature measurement was taken.

26. The system of claim 25 wherein in response to an out-of-range temperature measurement of a food item or food storage location the display displays a message that the measured temperature is out of range and a plurality of options to follow in response to the out-of-range temperature measurement including re-measuring the temperature or saving the out-of-range temperature to an action log.

27. The system of claim 25 wherein in response to selecting the option for saving the out-of-range temperature to the action log the processor initiates a corrective action process including a message on the display that includes the identity of the food item or food storage location subject to the corrective action, an instruction to bring the out of range temperature within the predetermined safe temperature range, which is displayed, and a first action log number which is the same as the measured temperature log number.

28. The system of claim 26 wherein one of the plurality of options also includes disposing of the food item.

29. The system of claim 27 wherein in response to selecting the option for saving the out-of-range temperature to the action log, the identity of the food item or food storage location, the out-range-temperature and an assigned action log number, which is the same as the measured temperature log number, are saved in an action log in the memory element which includes a predetermined time period within which the corrective action is to be completed.

30. The system of claim 29 wherein in response to commands input into the hand-held unit, the processor generates a menu on the displayed on the display which menu includes an action log mode for accessing one or more action log items saved in the memory element, and when selected a the temperature of the food item or food storage location is re-measured to determine if the out-range-temperature has been adjusted to fall within the predetermined safe temperature range and assigning a second action log number to the re-measured temperature that is the same as first action log number, which second action log number, re-measured temperature, the date and time of the re-measured temperature, which are different than the date and time of the out-of-range temperature measurement, are saved in the action log of the memory element.

31. The system of claim 30 wherein the memory element of the hand-held unit is linked to a computer for downloading data relative to temperature measurements of food items and food storage locations, including any out-of-range temperatures, the date and time of the temperature measurements, action log numbers and measured temperature log numbers associated with a food item or food storage location, and the computer having a software application for generating a temperature log for display on the computer and the software applicant can sort and arrange the data according to the action log numbers, measured temperature log numbers, the food items or food storage locations or the date and times of the temperature measurements.

32. A method for determining a condition of a food item or food storage location, comprising
measuring a food item or food storage location temperature;
determining a date and time at which the step of measuring the food item or food storage location temperature was executed;
storing the measured temperature and the date and time of the measured temperature;
storing a predetermined safe temperature range for the food item or the food storage location;
assigning a log number to each measured temperature and associated food item or food storage location;
generating a log of the measured temperature, the date and time of the measured temperatures and the log numbers associated therewith; and
providing a corrective action process responsive to an out-of-range food item or food storage location temperature, the corrective action process comprising processes for restoring the food item to a safe condition.

33. The method of claim 32 comprising providing a hand-held unit coupled to temperature probe and having a memory element in which data relative to measured temperatures of the food items and food storage locations, dates and times of the measured temperatures and log numbers associated therewith are stored, and a processor for generating the log.

34. The method of claim 33 comprising downloading the data to a computer having a software application that generates a temperature log for display on the computer and arranging the data in a chronological order of the dates and times of the measured temperatures or according to log numbers.

35. The method of claim 32 comprising entering an identification of a user executing the step of measuring the food item temperature and storing the identification of the user with the measured temperatures of the food items or food storage locations and the dates and times of measured temperatures and the associated log numbers.

36. The method of claim 32 providing a predetermined time period within which the corrective action process is to be completed.

37. The method of claim 36 comprising activating an alarm in the event the corrective action process has not been completed within the predetermined time period.

38. The method of claim 32 comprising providing a food storage location associated with each food item and saving the measured temperature associated with the food item and food storage location.
